(19) United States
(12) Patent Application Publication
(10) Pub. No.: US 2023/0157439 A1
(43) Pub. Date: May 25, 2023

(54) A CAMERA STRAP

(71) Applicant: Frii Designs AB, Solna (DE)

(72) Inventor: Jonas LUNDIN, Solna (DE)

(21) Appl. No.: 17/917,189

(22) PCT Filed: Apr. 6, 2020
(86) PCT No.: PCT/SE2020/050357

§ 371 Date: Oct. 5, 2022

(51) Int. Cl. A45F 5/00; G03B 17/56

(52) U.S. Cl. CPC A45F 5/00; G03B 17/561; A45F 2005/006; A45F 2200/0533

(57) ABSTRACT

A strap changeable between a first and second modes. In the first mode, the strap is movable, and, in the second, the strap is locked. The strap includes a mount removably attaching the strap to a camera. The mount includes a first strap portion that includes a first plurality of strap elements, each including a hole. The first strap portion further includes a first line connected to the mount and extending through the hole of each strap element of the first plurality such that the first plurality are arranged adjacent to each other along the first line. The mount includes a line tightening mechanism to tighten the first line to change the strap from the first mode to the second. The first plurality of strap elements, in the first mode, are movable, and, in the second, the first plurality of strap elements are locked.

### TECHNICAL FIELD

The present invention is related to a camera strap.

### BACKGROUND

In the field of photography it is important to have the camera close at hand at all times, in order not to miss a potential photograph, or video, opportunity. Hence, the solution has been to carry your camera in a strap around the neck and/or shoulder. Further, there are instances where a photographer has more time to set up for a photograph and may prioritize stability, or that he/she may want to be a part of the photograph. This has created the solution of camera tripods. Solutions according to, or similar to, the concepts mentioned above are generally able to produce the intended effect of keeping the camera close at hand or stabilizing/mounting a camera. Hence, there is a desire amongst photographers to be able to quickly adapt and/or react to their environment, in order to capture the best possible photograph(s). However, a photographer can only carry so much, and a camera bag may already be stuffed with different lenses and/or other camera accessories, which may not allow a photographer to bring a tripod (i.e. a camera stand/mount).

### SUMMARY

In view of the above discussion, a concern of the present invention is to provide a camera strap, which may be used as a camera strap and as a camera stand. To address at least one of these concerns and other concerns, a camera strap in accordance with the independent claim is provided. Preferred embodiments are defined by the dependent claims.

According to an aspect of the present invention a camera strap is provided. The camera strap is configured to be changeable between a first mode and a second mode. The strap, when in the first mode, is configured to be movable. The strap, when in the second mode, is configured to be locked in a rigid state. The strap comprises a mount. The mount is intended for removably attaching the strap to a camera. The strap further comprises a first strap portion. The first strap portion comprises a first plurality of strap elements, each comprising a hole extending through the strap element. The first strap portion further comprises a first line. The first line is connected to the mount. The first line extends through the hole of each strap element of the first plurality of strap elements such that the first plurality of strap elements are arranged adjacent to each other along the first line. The mount comprises a line tightening mechanism arranged to tighten the first line to change the strap from the first mode to the second mode. The first plurality of strap elements in the first mode are movable with regards to the adjacent strap elements. In the second mode, the first plurality of strap elements are locked with regard to the adjacent strap elements.

It is to be understood that by the term “strap”, it is further meant a belt, a carrying strap, and/or a shoulder-strap, for example. Additionally, the terms “strap” and “camera strap” may be used interchangeably within the application. Further, by the term “configured to be movable”, it is meant that the orientation of the different parts of the camera strap may be movable, in relation to each other, and that the shape of the camera strap may be changed, for example. By the term “configured to be locked in a rigid state”, it is meant that the orientation of the different parts of the camera strap may be rigid, in relation to each other, and that the shape of the camera strap may be in a fixed, or locked, state, for example. By the term “mount”, it is meant a support, an attachment means, a backing, or a setting, for example. The mount may comprise a screw. The screw may be any size, or thread standard. For example, the screw may be a ¼-20 Unified Thread Standard, UNC, thread or a ⅜-16 UNC thread. The mount may comprise a ball head, a pan-tilt head, or any other head type.

The first line may comprise a first end and a second end. The first end of the first line may be connected to the mount.

Thereby, it is to be understood that a strap element of the first plurality of strap elements may abut, and/or be in contact with, the mount. Further, the second end of the first line may be connected to a strap element of the first plurality of strap elements. Hence, the first plurality of strap elements may be arranged between the mount and an end of the first line. The plurality of strap elements may be movable along the first line, between the mount and an end of the first line. Hence, the stability of the camera strap may be increased. The stability of the camera strap may especially be increased while in the second mode.

The second end of the first line may be connected to the mount.

Hence, both ends of the first line of the first strap portion may be connected to the mount. The first strap portion may be viewed as a loop, wherein the first and the second ends of the first line of the first strap portion are connected to the mount. The first and the second ends of the first line may be connected to opposite sides of the mount. Hence, the stability of the camera strap may be increased. The stability of the camera strap may especially be increased while in the second mode. Further, the camera strap may be more easily carried.

The camera strap may further comprise a connecting portion. The connecting portion may be connected between the second end of the first line and the mount.

The connecting portion may be comprised by a fabric, or a soft, bendable and/or flexible plastic material, for example. At least a section of the connecting portion may comprise padding. The camera strap, when worn by a user, may be configured such that the connecting portion is in contact with the neck or shoulder of the user. The connecting portion may be further configured such that a section of the connecting portion comprising padding of the connecting portion may be in contact with the neck or shoulder of the user. Hence, the degree of comfort for a user carrying the camera strap may be increased. Further, the camera strap may be carried around the shoulder or neck of a user, while still being relatively small (i.e. having a relatively small volume). In other words, the connecting portion may have a smaller volume space than a strap portion of the same length.

The camera strap may further comprise a second strap portion. The second strap portion may comprise a second plurality of strap elements, each comprising a hole extending through the strap element. The second strap portion may comprise a second line, with a first and a second end. The first end of the second line may be connected to the mount. The second line may extend through the hole of each strap element of the second plurality of strap elements such that the second plurality of strap elements are arranged adjacent to each other along the second line. The line tightening mechanism may be further arranged to tighten the second line to change the strap from the first mode to the second mode. The second plurality of strap elements in the first mode may be movable with regards to the adjacent strap elements. In the second mode, the second plurality of strap elements may be locked with regard to the adjacent strap elements.

The second strap portion may be substantially identical to the first strap portion. However, the second strap portion may be the same length as, or shorter than, or longer than the first portion. The second end of the second line may be connected to a strap element of the second plurality of strap elements. Further, the present inventive concept should be understood to comprise a camera strap comprising a first and second strap portion, with one line, arranged to extend through the hole of each strap element of the first and second strap portions and the mount. Hence, the stability of the camera strap may be increased. The stability of the camera strap may especially be increased while in the second mode. Further, the addition of a second strap portion may allow for attaching and/or hugging the camera strap around objects, such as a branch or rod, while in the second mode. Further, the camera strap while in the second mode may be more stable while on uneven terrain.

The camera strap may further comprise a connecting portion. The connecting portion may be connected between the second end of the first line and the second end of the second line.

Hence, the degree of comfort for a user carrying the camera strap may be increased. Further, the camera strap may be carried around the shoulder or neck of a user, while still being relatively small (i.e. having a relatively small volume), due to a connecting portion having a smaller volume than a strap portion of the same length.

The second end of the first strap portion and the second end of the second strap portion may be configured to be connectable.

The camera strap may comprise at least one end cap. The end cap may be comprised by a strap portion. The at least one end cap may be arranged at a second end. The second end of the first strap portion and the second end of the second strap portion may be configured to be connectable via end caps arranged at the second ends of the first strap portion and the second strap portion. Hence, the camera strap may be easily mounted around an object or hung from an object, which may increase the number of potential photography opportunities, and thereby increase the versatility of the camera strap.

The first plurality of strap elements may comprise a plurality of first strap elements and a plurality of second strap elements. The first plurality of strap elements may be arranged adjacent to each other along the first line such that every other strap element along the first line is a first strap element.

The second plurality of strap elements may comprise a plurality of first strap elements and a plurality of second strap elements. The second plurality of strap elements may be arranged adjacent to each other along the second line such that every other strap element along the second line is a first strap element. In other words, the first or second plurality of strap elements may be arranged adjacent to each other along the first or second line such that every other strap element along the first or second line is a second strap element. By the term “every other”, it is also meant every second. Hence, the number of possible shapes that the camera strap may take is increased. Thereby, the stability of the camera strap may be increased. Additionally, the comfort of the user, while carrying the camera strap may be increased.

The first strap elements may comprise a tube-shaped body. The second strap elements may comprise a spherically shaped body.

The spherically shaped body may have a radius exceeding a radius of the tube-shaped body. The spherically shaped body may have a radius exceeding an inner radius of the tube-shaped body. However, the radius of the spherically shaped body may have a radius substantially equal to the inner radius of the tube-shaped body. By the term “tube-shaped”, it is also meant cylindrical and hollow, or elongated and hollow. The tube-shaped body may comprise indentations at each end of the tube-shaped body. The indentations of tube-shaped body may be adapted to receive a spherically shaped body. By the term “spherically shaped”, it is also meant round, circular, or ball-like. Hence, the stability and/or the structural integrity of the camera strap may be increased. Further, the comfort of the user, while carrying the camera strap may be increased.

In the second mode, at least a section of the spherically shaped body of the plurality of second strap elements may be inserted into the tube-shaped body of the adjacent first strap elements such that a peripheral surface of the tube-shaped body bear against the spherically shaped body.

In the second mode, at least the first line is tightened. In other words, in the second mode, the plurality of strap elements are tightened together, with regards to the line which extends through them. The spherically shaped body of the plurality of second strap elements may be hence be tightened towards the tube-shaped body of the adjacent first strap elements. Wherein the tightening may be such that at least a section of the spherically shaped body of the plurality of second strap elements is inserted into the tube-shaped body of the adjacent first strap element(s). By the term “at least a section of the spherically shaped body”, it is meant for example a tip, an end, or a side, for example. Thereby, the stability of the camera strap may be increased, especially while the camera strap is in the second mode.

The friction between adjacent strap elements may be higher in the second mode than in the first mode, such that the strap elements are locked with regard to the adjacent strap elements.

The friction between adjacent strap elements may be higher in the second mode than in the first mode, such that the strap elements are substantially locked with regard to the adjacent strap elements. The friction between adjacent strap elements may be increased by tightening at the first line and/or the second line. Therefore, the stability of the camera strap may be increased while in the second mode.

The camera strap may comprise at least one end cap. The at least one end cap may be arranged at a second end. The camera strap may comprise a locking member. The connecting portion may be configured as a tube arranged around the at least one end cap. The locking member may be arranged around the connecting portion. The locking member may be configured to clamp the connecting portion between the at least one end cap and the locking member, such that the connecting portion is locked with regards to the end cap.

The length of the camera strap may be the length of the connecting portion, and the first strap portion, and possibly the second strap portion. The length of the camera strap may hence be shortened by passing the connecting portion over the first (or second) strap portion. Correspondingly, the length of the camera strap may be lengthened by extracting, or pulling out, the first (or second) strap portion from the connecting portion. The length of the camera strap may be set by clamping the connecting portion and the locking member. The end cap may have a cone-shape or a truncated cone-shape. An outer circumference of the end cap may be smaller than an inner circumference of the locking portion. By the term “circumference”, it is also meant perimeter, or periphery, for example. The end cap may be adapted such that the outer circumference at one end of the end cap is smaller than at the opposite end of the end cap. The inner circumference of the locking portion may be smaller than an outer circumference of one end of the end cap, and bigger than at the opposite end of the end cap. Thereby, the end cap may be adapted as a wedge. The end cap may be configured to wedge into the locking portion. Thereby, the degree of comfort, for a user carrying the camera strap, may be increased.

The line tightening mechanism may be further arranged to tighten the first line to change the strap from the first mode to an intermediary mode and from the intermediary mode to the second mode. The plurality of strap elements in the intermediary mode may be less movable with regards to the adjacent strap elements compared to the plurality of strap elements in the first mode.

In the intermediary mode, the plurality of strap elements may be adjustable with regard to the adjacent strap elements. In other words, in the intermediary mode, the plurality of strap elements may be adjusted by force. The ease-of-use, for a user changing the camera strap from one mode to another mode may be increased. By first changing the camera strap to the intermediary mode before changing the camera strap to the second mode, the stability of the camera strap in the second mode may be increased.

The line tightening mechanism may be configured as at least one of a lever, a reel lock, a ratchet mechanism and a threaded bias mechanism.

The line tightening mechanism may be configured to tighten the first and/or the second line to change the camera strap from the first mode to the second mode. Further, the line tightening mechanism may be configured to tighten the first and/or the second line to change the camera strap from the first mode to the second mode, in a continuous manner. By the term “continuous manner”, it is for example meant that the tightening of the first and/or the second line may be increased, starting at a lowest level of tightness, corresponding to the first mode and ending at a highest level tightness, corresponding to the second mode. The intermediary mode may correspond to a level of tightness that is between the lowest level of tightness and the highest level of tightness. Hence, the ease-of-use, for a user changing the mode of the camera strap, may be increased.

The line tightening mechanism may be configured as a lever. The lever may be configured to be switchable between at least two discrete positions.

A position may correspond to the camera strap being in the first mode. Another position may correspond to the camera strap being in the second mode. A third position may correspond to the camera strap being in the intermediary mode. Thereby, the ease-of-use, for a user changing the mode of the camera strap, may be increased.

The mount may be comprised by a first mount portion, and a second mount portion. The mount may be configured to be changeable between a locked state and an open state. The first mount portion and the second mount portion, when in the locked state, may be locked together, and when in the open state, may be separated from each other.

The mount may be adapted as a clasp, a clamp or a clip. The first mount portion and the second portion may be configured to clasp, clamp or clip together. Further, the first mount portion and second mount portion may be configured to slide into each other, thereby changing from an open state to a locked state. Furthermore, the first mount portion and the second mount portion may be configured to be screwed together, thereby changing from an open state to a locked state. The first mount portion and/or the second mount portion may be intended for removably attaching the strap to a camera. Hence, the camera strap may be easily removed from the neck or shoulder of a user, or switched from a neck position to a shoulder position, or vice versa. Thereby, the degree of comfort of a user may be increased. Further, the ease-of-use of the camera strap may be increased.

### BRIEF DESCRIPTION OF THE DRAWINGS

Exemplifying embodiments of the invention will be described below with reference to the accompanying drawings.

FIG. 1 is a schematic and perspective view of a camera strap according to one or more exemplifying embodiments of the present invention.

FIG. 2 is a schematic and perspective view of a camera strap according to one or more exemplifying embodiments of the present invention.

FIG. 3 is a schematic and perspective view of a camera strap according to one or more exemplifying embodiments of the present invention.

FIG. 4 is a schematic and perspective view of a strap portion of a camera strap according to one or more exemplifying embodiments of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

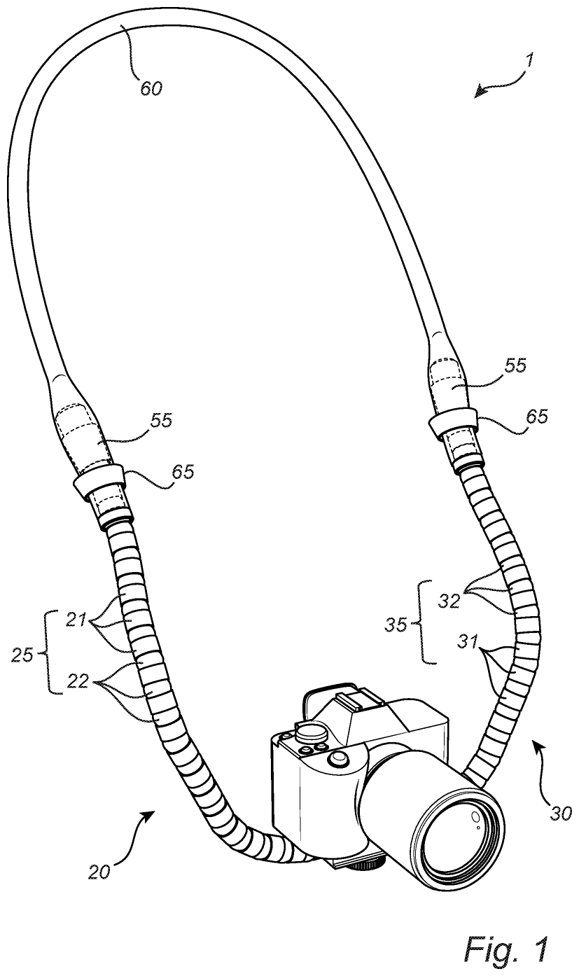

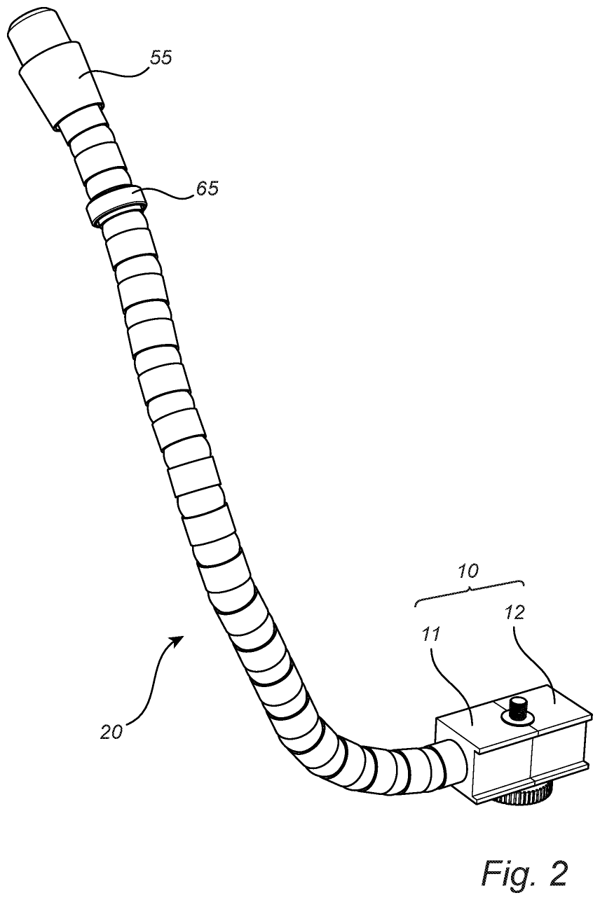

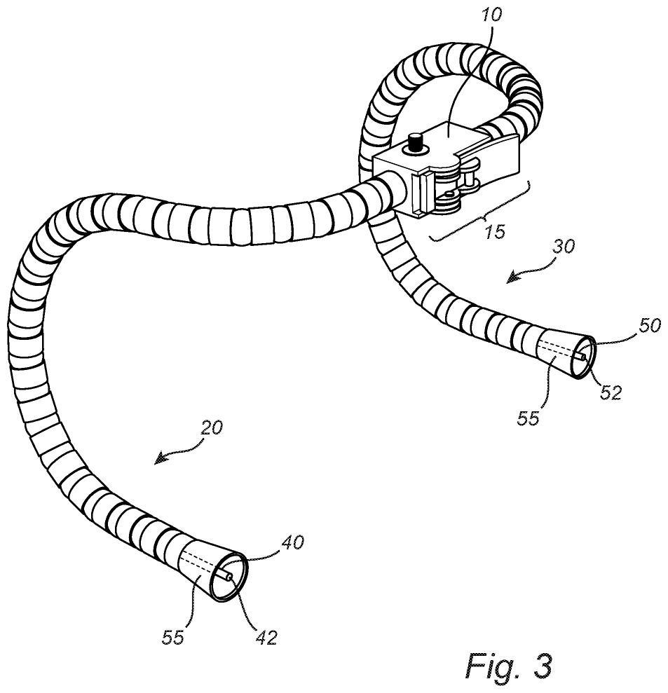

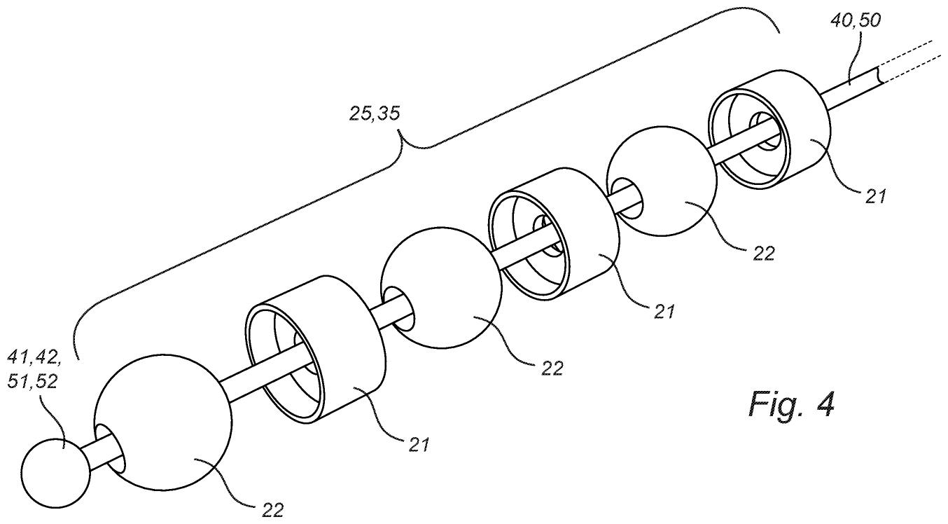

FIG. 1 is a schematic and perspective view of a camera strap according to one or more exemplifying embodiments of the present invention. The camera strap 1 in FIG. 1 is configured to be changeable between a first mode and a second mode. The strap 1, when in the first mode, is configured to be movable, and when in the second mode, is configured to be locked in a rigid state. The strap 1 shown in FIG. 1 comprises a mount 10 (not shown; see FIGS. 2 and 3), intended for removably attaching the strap 1 to a camera. In FIG. 1, a camera is shown as attached to the mount 10. The shown strap 1 comprises a first strap portion 20 and a second strap portion 30. The first and second strap portions 20,30 comprises a first plurality of strap elements 25 and a second plurality of strap elements 35, respectively. Each strap element comprises a hole extending through the strap element. The first and second strap portions 20,30 comprises a first line 40 (not shown; see FIG. 4) and a second line 50 (not shown; see FIG. 4), respectively. The first line has a first end 41 and a second end 42, and the second line has a first end 51 and a second end 52 (not shown; see FIG. 4). The first line 40 and the second line 50 are connected to the mount. The first line 40 extends through the hole of each strap element of the first plurality of strap elements 25 such that the first plurality of strap elements 25 are arranged adjacent to each other along the first line 40. The second line 50 extends through the hole of each strap element of the second plurality of strap elements 35 such that the second plurality of strap elements 35 are arranged adjacent to each other along the second line 50. The mount 10 comprises a line tightening mechanism 15 (not shown; see FIG. 3) arranged to tighten the first line 40 and/or the second line 50 to change the strap 1 from the first mode to the second mode. The first and the second pluralities of strap elements 25,35 in the first mode are movable with regards to the adjacent strap elements, and in the second mode the first and the second pluralities of strap elements 25,35 are locked with regard to the adjacent strap elements. The first ends 41,51 of the first line 40 and the second line 50 are connected to the mount 10. The shown strap 1 comprises a connecting portion 60. The connecting portion 60 is connected between the second ends 42, 52 of first line 40 and the second line 50, respectively. The first and the second plurality of strap elements 25, 35 comprise a plurality of first strap elements 21 and a plurality of second strap elements 22. The first and second plurality of strap elements 25,35 are arranged adjacent to each other along the first and second line 40,50 respectively, such that every other strap element along the first and the second line 40,50 is a first strap element 21. The first strap elements 21 comprise a tube-shaped body, and wherein the second strap elements 22 comprise a spherically shaped body. The spherically shaped body has a radius exceeding the radius of the tube-shaped body. A majority of the spherically shaped bodies are inside the two adjacent tube-shaped bodies of each spherically shaped body. The strap elements may be comprised by any material. For example, the strap elements may be comprised by plastic, rubber, metal, and or wood. Further, a strap element 21,22 may comprise a ring, arranged around the strap element 21, 22. The ring may be comprised by the same or a different material than the strap element 21,22. The ring may for example be comprised by rubber. The ring may improve the grip and/or friction of the camera trap while in the second mode. All the strap elements 21, 22 may have rings, or only the second strap elements 22 may have rings. Thereby, the ring(s) may help while the camera strap 1 is arranged to hang or to grip onto something, while in the second mode. The shown camera strap 1 further comprises two end caps 55. The end caps 55 are arranged at the second ends 42,52 of the first strap portion 20 and the second strap portion 30, respectively. The camera strap 1 further comprises two locking members 65. The connecting portion 60 is configured as a tube arranged around the two end caps 55. The connecting portion 60 is further configured as a tube arranged around at least a portion of the first and second strap portions 20,30. The locking member(s) 65 are arranged around the connecting portion 60, and configured to clamp the connecting portion 60 between the end cap(s) 55 and the locking member(s) 65, such that the connecting portion 60 is locked with regards to the end cap(s) 55. The connecting portion 60 further comprises two end members arranged at ends of the connecting portion 60 around the first strap portion 20 and second strap portion 30, respectively. The end members are adapted to prevent the connecting portion 60 from separating from the first strap portion 20 and the second strap portion 30.

However, the first line 40 (or the second line 50) may be arranged to extend through the hole of each strap element of the first and the second plurality of strap elements 25, 35 and the mount 10, such that the first and second plurality of strap elements 25,35 are arranged adjacent to each other along the first line 40 (or the second line 50). In other words, the camera strap 1 may comprise a first strap portion 10, a second strap portion 20 and a first or second line 40, 50, wherein the first or second line extends through the hole of each strap element of the first and second plurality strap elements 25. Thereby, the end caps 55 may be arranged at a first end 41,51 and/or a second end 42,52.

FIG. 2 is a schematic and perspective view of a camera strap 1 according to one or more exemplifying embodiments of the present invention. It should be noted that FIG. 2 comprises features, elements and/or functions as shown in FIG. 1 and described in the associated text. Hence, it is also referred to that figure and the description relating thereto for an increased understanding. A difference between the exemplary embodiment as shown in FIG. 1 and the exemplary embodiment as shown in FIG. 2 is that the camera strap 1 does not comprise a connecting portion 60. Further, the exemplary embodiment shown in FIG. 2 does not show a camera attached to the mount 10 of the camera strap 1. The camera strap 1 shown in FIG. 2 does not comprise a second strap portion 30, as shown in FIG. 1. The first end 41 of the first line 40 is connected to the mount 10. Further, the second end 42 of the first line 40 may be connected to the mount 10. Furthermore, the camera strap 1 may comprise a connecting portion 60 (not shown; see FIG. 1), connected between the second end 42 of the first line 40 and the mount 10. The shown camera strap 1 comprises an end cap 55 and a locking member 65. However, it should be understood that the present inventive concept is not limited to comprising either of an end cap 55 or a locking member 65. For example, the camera strap 1 could comprise an end cap 55, but not a locking member 65. Thereby, a connecting portion 60 may be connected between the end cap 55 and the mount 10. Further, the camera strap 1 could be connected to the mount 10 by the second end 42 of the first line 40. Hence, such an exemplary embodiment does not comprise either of an end cap 55 or a locking member 65. The mount 10 shown in FIG. 2 comprises a screw, intended for removably attaching the strap 1 to a camera. The shown screw is arranged through the mount 10. Further, the screw comprises a turning wheel. The turning wheel allowing attachment of a camera to the mount 10 via the screw. The screw could be fixed to the mount 10. The mount 10 further comprises camera padding (not shown), intended for securing a camera to mount 10. The mount 10 may be comprised by a first mount portion 11, and a second mount portion 12. The mount 10 may be configured to be changeable between a locked state and an open state, wherein the first mount portion 11 and the second mount portion 12, when in the locked state, are locked together, and when in the open state, are separated from each other. Either of the first mount portion 11 and the second mount portion 12 may comprise the locking mechanism 15. Further, either of the first mount portion 11 and the second mount portion 12 may comprise a screw, or other attachment means, for attaching a camera to the mount 10.

FIG. 3 is a schematic and perspective view of a camera strap according to one or more exemplifying embodiments of the present invention. It should be noted that FIG. 3 comprises features, elements and/or functions as shown in FIGS. 1 and 2 and described in the associated texts. Hence, it is also referred to those figures and the description relating thereto for an increased understanding. A difference between the exemplary embodiment as shown in FIG. 1 and the exemplary embodiment as shown in FIG. 3 is that there is no camera attached to the camera strap 1. Further, the camera strap 1 shown in FIG. 3 does not comprise a connecting portion 60 or a locking member 65. Additionally, the camera strap 1, shown in FIG. 3, is in the second mode. The camera strap 1 in the second mode is locked in a rigid state. The first strap portion 20 and the second strap portion 30 have been moved into a shape while in the first mode, and then locked in a rigid state, thereby keeping the shape. The shown shape is exemplary and the camera strap 1 may be in substantially any shape. The shape of the camera strap 1, while in the second state, may allow for the camera strap 1 to be configured as a camera stand. The second state may be understood as a camera stand state. The first state may be understood as a carrying and/or shaping state. In the second mode the friction between adjacent strap elements 25 is higher than in the first mode, such that the strap elements 25 are locked with regard to the adjacent strap elements 25. Additionally, in the second mode, at least a section of the spherically shaped body of the plurality of second strap elements 22 are inserted into the tube-shaped body of the adjacent first strap elements 21 such that an peripheral surface of the tube-shaped body bear against the spherically shaped body. The first line 40 and the second line 50 are arranged centrally through the first strap portion 20 and the second strap portion 30, respectively, and are arranged centrally in each respective end cap 55, wherein each line 40, 50 comprised a second end portion 42, 52. The mount 10 shown in FIG. 3 comprises a line tightening mechanism 15 arranged to tighten the first line 40 to change the strap 1 from the first mode to the second mode. The line tightening mechanism 15 may be configured to tighten the first line 40 and the second line 50. In FIG. 3, the line tightening mechanism 15 is configured as a lever. The lever is configured to be switchable between at least two discrete positions. the line tightening mechanism 15 may be further arranged to tighten the first line 40 to change the strap 1 from the first mode to an intermediary mode and from the intermediary mode to the second mode. The plurality of strap elements 25 in the intermediary mode are less movable with regards to the adjacent strap elements 25 compared to the plurality of strap elements 25 in the first mode. The lever may be in a middle position while in the intermediary mode. However, it is to be understood that the present inventive concept is not limited to the line tightening mechanism being configured as a lever. For example, the line tightening mechanism 15 may be configured as at least one of a lever, a reel lock, a ratchet mechanism and a threaded bias mechanism. Further, the camera strap 1 may comprise a connecting portion 60 connected between the first strap portion 20 and the second strap portion 30. Furthermore, the second end 42 of the first strap portion 20 and the second end 52 of the second strap portion 30 may be configured to be connectable. In other words, the end caps 55 of the first strap portion 20 and the second strap portion 30 may be configured to be connectable.

FIG. 4 is a schematic and perspective view of a strap portion of a camera strap 1 according to one or more exemplifying embodiments of the present invention. Further, FIG. 4 is an exploded view of a strap portion of a camera strap 1 according to one or more exemplifying embodiments of the present invention. It is to be understood that the strap portion 20, 30 shown in FIG. 4 may represent a first line 40 or a second line 50. The shown strap portion 20, 30 comprises a line 40, 50 and a plurality of strap elements 25, 35. The line 40, 50 comprises an end 41, 42, 51, 52 which is has a radius greater than the radius of the line 40, 50. However, the end 41, 42, 51, 52 may have the same radius as the line 40, 50. The line 40, 50 in FIG. 4 shows one end 41, 42, 51, 52, however it is to be understood that the line 40, 50 comprises another end. The shown plurality of strap elements 25, 35 each comprises a hole extending through the strap element 21, 22. The first strap elements 21 comprise a tube-shaped body. The second strap elements 22 comprise a spherically shaped body. The spherically shaped body has a radius substantially equal to the inner radius of the tube-shaped body. The spherically shaped body may have a radius which is smaller than the inner radius of the tube-shaped body. However, the spherically shaped body may have a radius exceeding the inner radius of the tube-shaped body. The shown first strap elements 21 further comprises a bottom, with a centrally arranged hole, which the line 40, 50 passes through. The bottom may be arranged to support an abutting second strap portion 22, when in a locked mode. The strap portion 20, 30 shown in FIG. 4 comprises three first strap elements 21 and three second strap elements 22. It is to be understood that this is purely exemplary, and the strap portion 20, 30 may comprise and number of first strap elements 21 and second strap elements 22, such as four, five, six, seven, eight, ten, twelve, fourteen, sixteen, eighteen, any number in between, or more. The plurality of strap elements 25, 35 are configured such that, in the second mode, at least a section of the spherically shaped body of the plurality of second strap elements 22 are inserted into the tube-shaped body of the adjacent first strap elements 21 such that a peripheral surface of the tube-shaped body bear against the spherically shaped body. The spherically shaped body may bear against the bottom of the tube-shaped body.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A camera strap, configured to be changeable between a first mode and a second mode, wherein the strap, when in the first mode, is configured to be movable, and when in the second mode, is configured to be locked in a rigid state; the strap comprising:
a mount, intended for removably attaching the strap to a camera;
a first strap portion; comprising:
a first plurality of strap elements, each comprising a hole extending through the strap element; and
a first line connected to the mount, the first line extends through the hole of each strap element of the first plurality of strap elements such that the first plurality of strap elements are arranged adjacent to each other along the first line; wherein
the mount comprises a line tightening mechanism arranged to tighten the first line to change the strap from the first mode to the second mode; and wherein
the first plurality of strap elements in the first mode are movable with regards to the adjacent strap elements, and
in the second mode the first plurality of strap elements are locked with regard to the adjacent strap elements.

2. A camera strap according to claim 1, wherein said first line comprises a first end and a second end, and wherein the first end is connected to the mount.

3. A camera strap according to claim 2, wherein the second end of the first line is connected to the mount.

4. A camera strap according to claim 2, further comprising:
a connecting portion, connected between the second end of the first line and the mount.

5. A camera strap according to claim 2, further comprising:
a second strap portion, comprising:
a second plurality of strap elements, each comprising a hole extending through the strap element; and
a second line, with a first and a second end, the first end of the second line being connected to the mount, the second line extends through the hole of each strap element of the second plurality of strap elements such that the second plurality of strap elements are arranged adjacent to each other along the second line; and
wherein the line tightening mechanism is further arranged to tighten the second line to change the strap from the first mode to the second mode; and wherein
the second plurality of strap elements in the first mode are movable with regards to the adjacent strap elements, and
in the second mode the second plurality of strap elements are locked with regard to the adjacent strap elements.

6. A camera strap according to claim 5, further comprising:
a connecting portion, connected between the second end of the first line and the second end of the second line.

7. A camera strap according to claim 5, wherein the second end of the first strap portion and the second end of the second strap portion are configured to be connectable.

8. A camera strap according to claim 1, wherein the first plurality of strap elements comprise:
a plurality of first strap elements, and
a plurality of second strap elements, and wherein
the first plurality of strap elements are arranged adjacent to each other along the first line such that every other strap element along the first line is a first strap element.

9. A camera strap according to claim 8, wherein the first strap elements comprise a tube-shaped body, and wherein the second strap elements comprise a spherically shaped body.

10. A camera strap according to claim 9, wherein, in the second mode, at least a section of the spherically shaped body of the plurality of second strap elements are inserted into the tube-shaped body of the adjacent first strap elements such that an peripheral surface of the tube-shaped body bear against the spherically shaped body.

11. A camera strap according to claim 1, wherein in the second mode the friction between adjacent strap elements is higher than in the first mode, such that the strap elements are locked with regard to the adjacent strap elements.

12. A camera strap according to claim 4, further comprising:
at least one end cap, arranged at a second end, and
a locking member; and
wherein the connecting portion is configured as a tube arranged around the at least one end cap; and
wherein the locking member is arranged around the connecting portion, and configured to clamp the connecting portion between the at least one end cap and the locking member, such that the connecting portion is locked with regards to the at least one end cap.

13. A camera strap according to claim 1, wherein the line tightening mechanism is further arranged to tighten the first line to change the strap from the first mode to an intermediary mode and from the intermediary mode to the second mode; and wherein
the plurality of strap elements in the intermediary mode are less movable with regards to the adjacent strap elements compared to the plurality of strap elements in the first mode.

14. A camera strap according to claim 1, wherein the line tightening mechanism is configured as at least one of a lever, a reel lock, a ratchet mechanism and a threaded bias mechanism.

15. A camera strap according to claim 14, wherein the line tightening mechanism is configured as a lever, configured to be switchable between at least two discrete positions.

16. A camera strap according to claim 1, wherein the mount is comprised by a first mount portion, and a second mount portion, wherein
the mount is configured to be changeable between a locked state and an open state, wherein the first mount portion and the second mount portion, when in the locked state, are locked together, and when in the open state, are separated from each other.
